(19) United States
(12) Patent Application Publication
(10) Pub. No.: US 2013/0062548 A1
(43) Pub. Date: Mar. 14, 2013

(54) Backseat assembly for expanding gate valve

(71) Applicant: Masahiro Yokomi, Chiba (JP)

(72) Inventor: Masahiro Yokomi, Chiba (JP)

(73) Assignee: TIX-IKS Corporation, Tokyo (JP)

(21) Appl. No.: 13/317,780

(22) Filed: Oct. 28, 2011

(30) Foreign Application Priority Data
Sep. 9, 2011 (JP) 2011-196655

(51) Int. Cl. F16K 3/30

(52) U.S. Cl. 251/328

(57) ABSTRACT

A backseat assembly includes: a housing that includes a bonnet and a tubular portion and forms a void and a passageway therein; a gate/segment assembly that includes a gate and a segment; a stem that moves upward or downward along with the gate while being connected to the gate; an elastic stopper that is provided in the bonnet so as to be located at a position facing the front end of the segment; a sealing surface that is formed on the bonnet; and a sealing surface that is formed on the stem and engages with the sealing surface formed on the bonnet, wherein when the gate valve is in the fully open position, a metal sheet is formed between the sealing surfaces respectively formed on the bonnet and the stem, and the segment is biased downward relative to the gate by the stopper.

### INCORPORATION BY REFERENCE

The present application claims priority from Japanese application JP2011-196655 filed on Sep. 9, 2011, the content of which is hereby incorporated by reference into this application.

### BACKGROUND OF THE INVENTION

(1) Field of the Invention

The present invention relates to an expanding gate valve, and particularly, to a backseat assembly for an expanding gate valve.

(2) Description of Related Art

An expanding gate valve is a valve in which an assembly (a gate/segment assembly) serving as a valve assembly accommodated inside a housing of the valve and including a gate and a segment is operated in the direction perpendicular to a passageway so as to open or close the passageway. When the valve is located at a fully closed position and a fully open position, the width of the assembly (the gate/segment assembly) including the gate and the segment increases, and the assembly is pressed against a valve seat provided in the passageway, so that a void and the passageway inside the housing are isolated from each other. In the state where the valve moves to the fully closed position or the fully open position, the gate/segment assembly decreases in width, so that the valve may move more easily.

Ports are Respectively Provided in the Gate and the Segment.

If a stem connected to the gate moves upward when the valve is in the fully close position, the gate/segment assembly moves upward. Then, when the segment comes into contact with a bonnet, the segment will stop. Subsequently, if the stem moves further upward, only the gate moves upward, and the width of the gate/segment assembly increases, so that the valve reaches the fully open position. At the fully open position, the ports of the gate and the segment communicate with the passageway.

In such an expanding gate valve, a backseat is provided so as to seal and isolate the void inside the housing from the outside of the valve. For example, the backseat assembly is used to seal and isolate the void inside the housing from the outside of the valve by moving the stem upward to the fully open position so that a sealing surface formed on the stem comes into close contact with a sealing surface formed on the bonnet of the housing.

However, in order for the expanding gate valve to be equipped with the function of the backseat, the position of the stem when the gate/segment assembly is expanded at the fully open position and the assembly is pressed against the valve seat by a sufficient force needs to accurately match the position of the stem when the sealing surface of the stem comes into close contact with the sealing surface of the bonnet. However, the expanding gate valve satisfying such a demand is not able to be manufactured.

U.S. Pat. No. 5,435,520 discloses a backseat assembly for an expanding gate valve including a seal member that is slidable around a stem; and a coil spring that biases the seal member so as to be separated from a gate. Here, when the gate and the segment move to the fully open position of the valve, the segment does not move any further since the segment engages with the bonnet, and the stem and the gate keep moving while engaging with an annular sheet of a housing so that the seal member seals a gap between the stem and the housing. The seal member engages with the annular sheet, and the seal member is biased in advance by the coil spring.

### BRIEF SUMMARY OF THE INVENTION

However, the backseat assembly of U.S. Pat. No. 5,435,520 has a structure in which the gate is moved relative to the segment by using the coil spring. However, the force of the coil spring is weak, so that the passageway may not be completely isolated from the fluid of the void inside the housing of the valve.

An object of the invention is to provide a backseat assembly for an expanding gate valve that is normally operated regardless of whether the position of the stem when the gate/segment assembly is expanded at the fully open position and the assembly is pressed against the valve seat by a sufficient force does not match the position of the stem when the sealing surface of the stem comes into close contact with the sealing surface of the bonnet.

Furthermore, another object of the invention is to provide a backseat assembly for an expanding gate valve that moves the segment and the gate relative to each other with sufficient force to completely isolate the passageway from the void inside the housing at the fully open position.

Furthermore, still another object of the invention is to provide a backseat assembly for an expanding gate valve that does not need to provide the seal member by adopting the metal seal as the backseat.

According to an aspect of the invention, there is provided a backseat assembly for an expanding gate valve including: a housing that includes a bonnet and a tubular portion and forms a void and a passageway therein; a gate/segment assembly that includes a gate and a segment; a stem that is connected to the gate and moves upward or downward along with the gate; an elastic stopper that is provided in the bonnet so as to be located at a position facing the front end of the segment; a sealing surface that is formed on the bonnet; and a sealing surface that is formed on the stem and engages with the sealing surface formed on the bonnet, wherein when the expanding gate valve is located at the fully open position, a metal sheet is formed between the sealing surfaces respectively formed on the bonnet and the stem, and the segment is biased downward relative to the gate by the elastic stopper.

The Elastic Stopper May be a Plate Spring.

When the expanding gate valve is in the fully open position, the plate spring may be deformed in the range of 1 mm to 3 mm.

According to the backseat assembly of the expanding gate valve of the embodiment, as the backseat assembly, the elastic stopper is attached to the bonnet so as to be located at a position facing the front end of the segment. Accordingly, even if the position of the stem when the gate/segment assembly is expanded and the assembly is pressed against the valve seat with sufficient force does not accurately match the position of the stem when the sealing surface of the stem comes into close contact with the sealing surface of the bonnet in the state where there is a slight deviation between the two positions, the deviation may be absorbed by the elastic force of the stopper. Therefore, the function of the backseat may be reliably exhibited.

Furthermore, according to the backseat assembly for the expanding gate valve of the invention, the elastic stopper (the plate spring) is provided in the bonnet so as to be located at a position facing the front end of the segment. Accordingly, since the stopper has sufficiently large elasticity compared to the coil spring, it is possible to obtain a force which is enough to completely isolate the passageway from the void inside the housing.

Furthermore, in the backseat assembly for the expanding gate valve of the invention, since the stem is provided with the sealing surface for the backseat, the seal member is not needed. Therefore, a metal seal may be formed between the stem and the gate. In particular, the backseat assembly of the invention may be best suitable for a geothermal expanding gate valve which may not use a seal member at a high temperature.

### BRIEF DESCRIPTION OF SEVERAL VIEWS OF DRAWING

FIG. 1 is a longitudinal cross-sectional view showing an expanding gate valve according to an embodiment of the invention.

FIG. 2 is an enlarged longitudinal cross-sectional view showing a part of the expanding gate valve of the embodiment of FIG. 1.

FIG. 3 is a transverse cross-sectional view showing a stopper (a plate spring) of the expanding gate valve of the embodiment of FIG. 1.

FIG. 4 is a longitudinal cross-sectional view showing the stopper (the plate spring) of the expanding gate valve of the embodiment of FIG. 1.

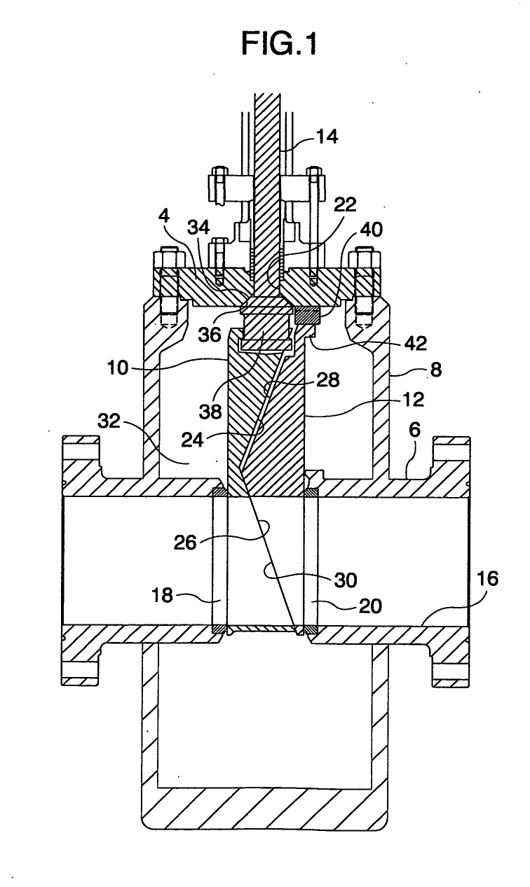

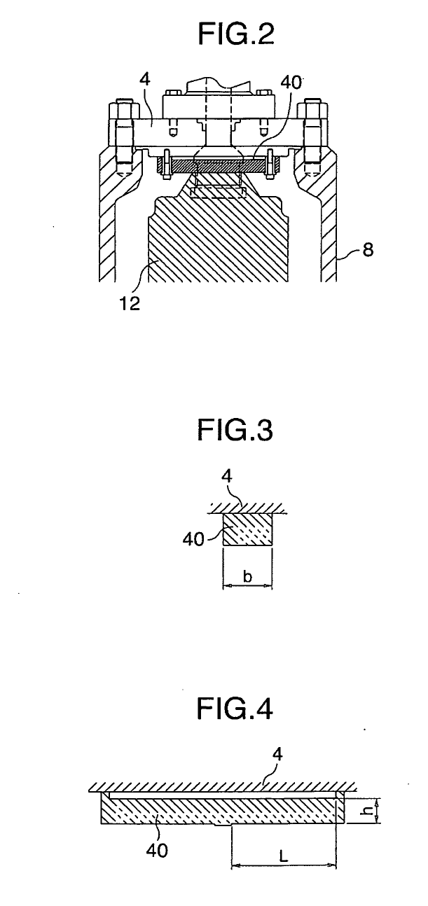

### DETAILED DESCRIPTION OF THE INVENTION

Hereinafter, an embodiment of the invention will be described by referring to the drawings.

The expanding gate valve of the embodiment includes a housing 8, a gate/segment assembly 10, 12 and a stem 14. The housing 8 has a bonnet 4 and a tubular portion 6. The gate/segment assembly includes a gate 10 and a segment 12 and serves as a valve assembly accommodated inside the housing 8. The stem 14 is connected to the gate 10. The tubular portion 6 of the housing 8 forms therein a passageway 16. The expanding gate valve further includes valve seats 18 and 20 that are provided in the passageway 16 inside the housing 8 so as to face each other. A penetration hole 22 is provided in the bonnet 4 so that the gate 10 is movable upward and downward therethrough.

The gate/segment assembly 10, 12 is operated in the direction (the up-down direction) perpendicular to the passageway 16 so as to open or close the passageway 16. The gate 10 includes upper and lower slopes 24 and 26, and the segment 12 includes upper and lower slopes 28 and 30 which can engage with slopes 24 and 26, respectively, of the gate 10.

When the valve is in the fully open position and the fully closed position, the gate/segment assembly 10, 12 increases in width, and is pressed against the valve seats 18 and 20 of the tubular portion 6. In the state where the valve moves to the fully open position or the fully closed position, the gate/segment assembly 10, 12 decreases in width, so that the valve can move more easily.

Ports (not shown) are respectively provided in the gate 10 and the segment 12. When the gate valve is in the fully open position, the ports and the passageway 16 are aligned with each other, so that the upstream and the downstream of the passageway 16 communicate with each other.

More specifically, the upper slopes 24 and 28 of the gate/segment assembly 10, 12 come into contact with each other when the stem 14 moves downward. When the segment 12 can not move upward or downward any further, the gate 10 moves further downward along the slopes 24 and 28 of the gate/segment assembly 10, 12. As a result, the gate/segment assembly 10, 12 increases in width so as to be strongly pressed against the valve seats 18 and 20 provided in the tubular portion 6 of the housing 8, so that the upstream and the downstream of the passageway 16 are mechanically sealed and isolated from each other.

The lower slopes 26 and 30 of the gate/segment assembly 10, 12 come into contact with each other when the stem 14 moves upward, so that the gate/segment assembly 10, 12 moves upward. In the conventional expanding gate valve, when the segment 12 comes into contact with the bonnet 4, the segment 12 will stop and subsequently, and thereafter, when the stem 14 moves further upward, only the gate 10 moves further upward along the slopes 26 and 30 which are engaging with each other, so that the width of the gate/segment assembly 10, 12 increases. At the fully open position, the gate/segment assembly 10, 12 is strongly pressed against the valve seats 18 and 20 provided in the passageway 16 of the housing 8 and facing each other, so that a void 32 and the passageway 16 inside the housing 8 are isolated from each other. At this time, the upstream and the downstream of the passageway 16 communicate with each other through the ports respectively provided in the gate 10 and the segment 12.

The backseat assembly which seals and isolates the outside of the valve from the void 32 inside the housing 8 according to the embodiment will be described. The backseat assembly seals and isolates the void 32 inside the housing 8 and the outside of the housing 8 from each other by moving the stem 14 upward to the fully open position so that a sealing surface 34 formed on the stem 14 comes into close contact with a sealing surface 36 formed on the bonnet 4.

The lower front end of the stem 14 is provided with an expanding portion 38 with a tapered portion. Furthermore, the bonnet 4 has a tapered portion corresponding to the tapered portion of the stem 14. That is, the vicinity of the lower opening portion of the penetration hole 22 of the bonnet 4 increases in the diameter, so that the expanding portion 38 of the stem 14 engages with the lower end of the stem 14 at the tapered portions thereof when the stem 14 moves upward to the fully open position.

A stopper 40 which is formed of an elastic body is attached to the bonnet 4 so as to be located at a position facing the upper end of the segment 12 at the fully open position. The stopper 40 is a plate spring, for example. The upper end of the segment 12 is provided with an extending portion 42 which protrudes in the direction of the passageway 16 so as to increase the contact area between the segment 12 and the stopper 40.

The operation of the backseat assembly according to the embodiment will be described.

When the stem 14 moves upward, the segment 12 comes into contact with the stopper 40. When the stem 14 further moves upward, the tapered portion of the front end of the stem 14 comes into close contact with the tapered portion of the lower portion of the bonnet 4 which engages with the tapered portion. By the close contact between the stem 14 and the bonnet 4, the tapered portions respectively serve as the sealing surfaces 34 and 36, so that the void 32 inside the housing 8 is sealed and isolated from the outside of the housing 8 or the bonnet 4. Thus, the positions of the stem 14 and the gate 10 connected to the stem 14 in the up-down direction are fixed, whereas the segment 12 is pressed downward relative to the gate 10 along the slopes 26 and 30 of the gate/segment assembly due to the elastic force of the stopper 40, so that the width of the gate/segment assembly 10, 12 increases and the gate/segment assembly 10, 12 is pressed against the valve seats 18 and 20. Accordingly, the fluid inside the passageway 16 is isolated and sealed from the void 32 of the housing 8.

At this time, it is desirable that the stopper 40 be deformed in the range of 1 mm to 3 mm, for example, in the case of 12 inch (300 mm) of expanding gate valve, more specifically, API6D “Specification for Pipeline Valves” 12 inch Class 600 Gate Valve. However, the invention is not limited thereto as long as the stopper may be deformed so that the segment and the gate move relative to each other by a force enough to isolate the passageway from the void inside the housing at the fully open position.

Furthermore, the stopper 40 is designed so that the deformation does not exceed the allowable stress of the material.

In the expanding gate valve of the embodiment, as the backseat assembly, the elastic stopper 40 is attached to the bonnet 4 so as to be located at a position facing the upper end of the segment 12 at the fully open position. Accordingly, even if the position of the stem 14 when the gate/segment assembly 10, 12 is expanded and the assembly is pressed against the valve seats 18 and 20 with sufficient force does not accurately match the position of the stem 14 when the sealing surface 34 of the stem 14 comes into close contact with the sealing surface 36 of the bonnet 4, a slight deviation between the two positions may be absorbed by the elastic force of the stopper 40. Therefore, the function of the backseat may be reliably exhibited.

Hereinafter, the material, the shape, and the like of the stopper 40 will be described.

As the material of the stopper 40, for example, JIS G4303 SUS (17-4ph steel), JIS G4053 SCM430, SCM435, and SCM440 (Cr—Mo steel) may be used.

In the expanding gate valve of the above-described API6D “Specification for Pipeline Valves” 12 inch Class 600 Gate Valve, when a force in which the stopper 40 of the embodiment presses the segment 12 downward relative to the gate 10 and the gate/segment assembly 10, 12 comes into close contact with the valve seats 18 and 20 so as to isolate the fluid inside the passageway 16 from the void 32 inside the housing 8 is obtained by an experiment, the force is about 5000 kg.

When the deformation 5 (mm) of the stopper 40 is set to 2 mm, the equation of δ=7L³W/bh³E=2 mm is established.

Here, as shown in FIGS. 3 and 4, L denotes the length (mm) of the arm of the stopper 40, W denotes the downward force (kg) exerted on the segment 12, b denotes the width (mm) of the stopper 40, h denotes the thickness (mm) of the stopper 40, and E denotes the longitudinal elastic coefficient.

When L, W, b, h and E are set to 140 mm, 5,000 kg, 60 mm, 32 mm, and 21,000 kg/mm², respectively, then the stress σ (kg/mm²) of the stopper 40 is obtained as follows:

$$\begin{matrix}σ = 3 LW / {bh}^{2} \\ = 34.2 kg / {mm}^{2}\end{matrix}$$

The calculation result was confirmed by an experiment using displacement measurement and stress measurement.

Therefore, the material of the stopper 40 needs to be selected so that the stress a does not exceed the allowable stress of the material. The allowable stresses of JIS G4303 SUS (17-4ph steel), JIS G4053 SCM430, SCM435, and SCM440 (Cr—Mo steel) are over 34.2 kg/mm².

While the present invention has been described with reference to the exemplary embodiment, it is to be understood that the invention is not limited to the disclosed exemplary embodiment. The invention also includes an embodiment modified by the person skilled in the art and apparently understood from the description of the specification and the accompanied drawings.

### DESCRIPTION OF REFERENCE SIGNS

4: BONNET
6: TUBULAR PORTION
8: HOUSING
10: GATE
12: SEGMENT
14: STEM
16: PASSAGEWAY
18, 20: VALVE SEAT
22: PENETRATION HOLE
24, 26: SLOPE OF GATE
28, 30: SLOPE OF SEGMENT
32: VOID
34: SEALING SURFACE FORMED ON STEM
36: SEALING SURFACE FORMED ON BONNET
38: EXPANDING PORTION OF STEM
40: PLATE SPRING (STOPPER)
42: EXTENDING PORTION OF SEGMENT

1. A backseat assembly for an expanding gate valve comprising:
a housing including a bonnet and a tubular portion and being formed therein a void and a passageway;
a gate/segment assembly including a gate and a segment;
a stem connected to the gate and moving upward or downward along with the gate;
an elastic stopper mounted at the bonnet so as to be located at a position facing the front end of the segment;
a first sealing surface being formed on the bonnet; and
a second sealing surface being formed on the stem and engaging with the first sealing surface,
wherein when the expanding gate valve is in a fully open position, a metal sheet is formed between the sealing surfaces respectively formed on the bonnet and the stem, and the segment is biased downward relative to the gate by the elastic stopper.

2. The backseat assembly for the expanding gate valve according to claim 1,
wherein the stopper is a plate spring.

3. The backseat assembly for the expanding gate valve according to claim 1,
wherein when the expanding gate valve is in a fully open position, the stopper is deformed in the range of 1 mm to 3 mm.

4. The backseat assembly for the expanding gate valve according to claim 2,
wherein when the expanding gate valve is in a fully open position, the stopper is deformed in the range of 1 mm to 3 mm.
